(19) United States
(12) Patent Application Publication
(10) Pub. No.: US 2017/0351403 A1
(43) Pub. Date: Dec. 7, 2017

(54) PRESSURE CONFORMING THREE-DIMENSIONAL ICONS

(71) Applicant: Futurewei Technologies, Inc., Plano, TX (US)

(72) Inventors: Reza Yazdani, Los Altos, CA (US); Zongfang Lin, Santa Clara, CA (US); Chen Tian, Union City, CA (US)

(73) Assignee: Futurewei Technologis, Inc., Plano, TX (US)

(21) Appl. No.: 15/175,941

(22) Filed: Jun. 7, 2016

(51) Int. Cl. G06F 3/0481; G06T 15/20; G06T 11/00; G06F 3/041; G06F 3/0484; G06T 15/80; G06T 15/08

(52) U.S. Cl. CPC G06F 3/04817; G06T 15/80; G06T 15/20; G06T 15/08; G06F 3/0414; G06F 3/04845; G06F 3/04842; G06T 11/001

(57) ABSTRACT

A computing device is provided, including a display configured to display images, a pressure sensor configured to sense at least one of a pressure and a force on the display, and a processor configured to generate a dynamic icon having an image for display on the display, wherein the image is two-dimensional or three-dimensional in appearance, the processor changing an appearance of the image on the dynamic icon upon the pressure sensor sensing at least one of a pressure and a force on the icon.

### BACKGROUND

Traditional graphical icons on smart phones and the like have a single layer of functionality in that they launch a single application or function when selected. Recently, pressure-sensitive icons have been developed for touch sensitive displays capable of multiple layers of functionality. These icons make use of a pressure sensor within the touch sensitive display to measure a pressure against the icon. A first application function may be performed when a first pressure is applied to an icon, and a second application function may be performed when a second pressure is applied to the icon. Regardless of whether an icon is single layer or multiple layer icon, the icons are static. That is, the icons do not change appearance when pressed.

### SUMMARY

In one embodiment, the present technology relates to a computing device, comprising: a display configured to display images; a pressure sensor configured to sense at least one of a pressure and a force on the display; and a processor configured to generate a dynamic icon having an image for display on the display, wherein the image is two-dimensional or three-dimensional in appearance, the processor changing an appearance of the image on the dynamic icon upon the pressure sensor sensing at least one of a pressure and a force on the icon.

In another embodiment, the present technology relates to a method, comprising: displaying a dynamic icon on a graphical user interface, the dynamic icon comprising an image; sensing different pressures exerted on the dynamic icon; and changing the appearance of the image as a function of the sensed pressure exerted on the dynamic icon.

In a further embodiment, the present technology relates to a non-transitory computer-readable medium storing computer instructions for operating a user interface, that when executed by one or more processors, cause the one or more processors to perform the steps of: displaying a dynamic icon on the user interface, wherein the image is two-dimensional or three-dimensional in appearance; sensing a pressure exerted on the dynamic icon; and changing the appearance of the image as a function of the sensed pressure exerted on the dynamic icon.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is top view of a user interface including dynamic 3D icons on a computing device.

FIGS. 2A-19C are various top views and virtual depth views of dynamic 3D icons according to embodiments of the present technology.

FIG. 20 is a flowchart showing the operation of an embodiment of the present technology.

FIG. 21 is a flowchart showing the operation of an alternative embodiment of the present technology.

FIGS. 22A-22C are various top views of a 3D icon on a computing device having predefined trigger states associated with triggering a computer operation.

FIG. 23 is a flowchart showing the operation of an embodiment of the present technology including predefined trigger states associated with triggering a computer operation

FIG. 24 is a block diagram of a sample computing device for implementing aspects of the present technology.

### DETAILED DESCRIPTION

The present technology, roughly described, relates to a graphical user interface comprising one or more dynamic three-dimensional (3D) icons. A dynamic 3D icon is an icon displayed on a display of the graphical user interface whose appearance changes as a function of how hard the dynamic 3D icon is pressed. In embodiments, the displayed shape of the icon may change as a function of pressure. Additionally or alternatively the displayed color of the icon may change as a function of pressure.

The icon may include an image that is presented with visual effects making the icon a dynamic 3D icon that gives the appearance of compressing in a virtual depth direction as a function of pressure. In further embodiments, the icon may include a two-dimensional (2D) image in a plane of the icon making the icon a dynamic 2D icon that changes appearance in the plane of the icon.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

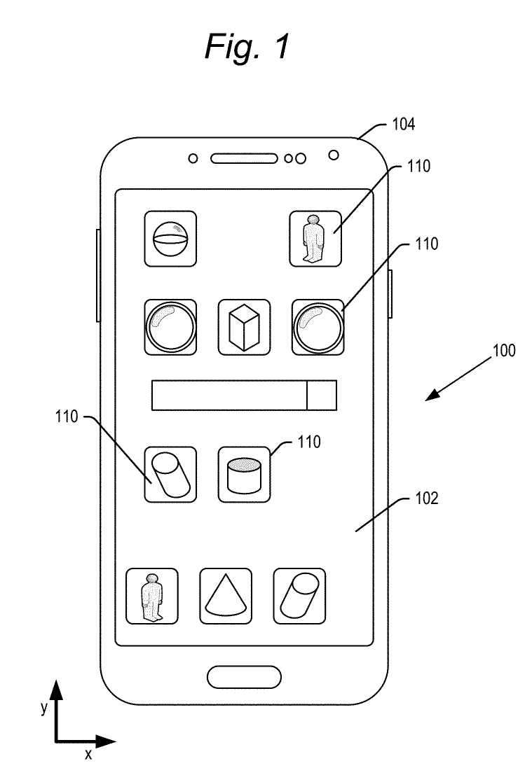

FIG. 1 is a top view of a graphical user interface 100 including a touch-sensitive display 102 presented on or by a computing device 104. In the embodiment shown in FIG. 1, the computing device 104 may be a mobile phone. However, it is understood that the computing device 104 may be any computing device having a touch-sensitive display including for example a laptop, tablet, desktop computer, gaming console, computer within an automobile or smart appliance and other computing systems. Display 102 may include a touch-sensitive interface capable of receiving touch input according to any of a variety of known touchscreen technologies. For example, display 102 may sense touch input by resistive, capacitive, surface acoustic wave or other technologies. In embodiments, the touch-sensitive display may receive touch input through contact by a user's finger or other body part and/or via a stylus.

The user interface 100 may include one or more dynamic 3D icons 110 (some of which are numbered). A 3D icon is a discrete two-dimensional image presented on display 102 representing a computer command or computer file which is drawn with perspective, shading and/or other visual effects so as to appear to be three-dimensional. The images on the icons 110 may for example be pictures, symbols or shapes. 3D icons may be dynamic 3D icons 110 in accordance with the present technology, in that their appearance changes as a function of pressure on the icon as explained below. The display 102 may also optionally display one or more conventional 2D or 3D static icons whose appearance does not change as a function of received pressure.

The particular layout of 3D dynamic icons 110 shown in FIG. 1 is by way of example, and it is understood that the number, arrangement and size of the dynamic 3D icons may vary in further embodiments. The number, arrangement and/or size of the dynamic 3D icons may be provided in a default configuration set by an operating system of the computing device 104, but may also be user-configurable.

The pictures/symbols/shapes shown on dynamic 3D icons 110 in FIG. 1 is also by way of example, and may be any picture, symbol or shape in further embodiments. The size of the dynamic 3D icons 110 shown in FIG. 1 is also by way of example, and the size of the icons 110 may vary in further embodiments relative to each other and/or the overall size of the display 102. FIG. 1 further shows a reference coordinate system arranged such that the display 102 and icons 110 lie in an x-y plane having orthogonal x and y-axes. A z-axis is further defined which is orthogonal to the x, y axes (into and out of the page of FIG. 1).

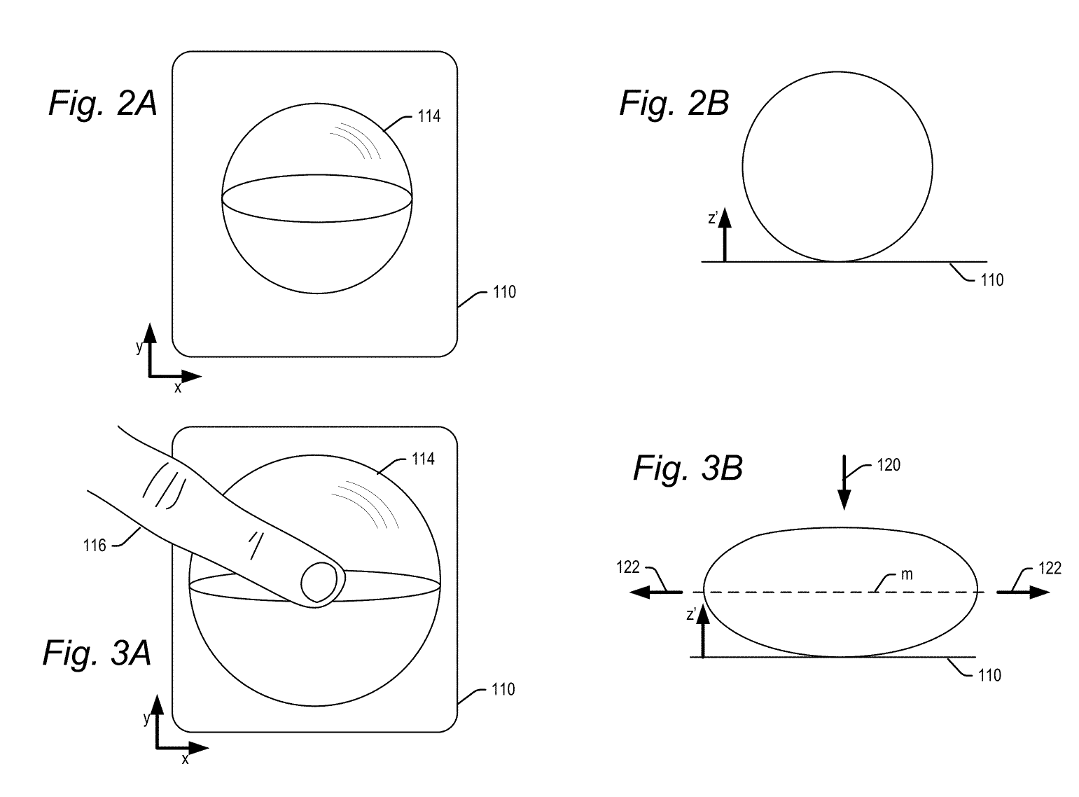

FIGS. 2A-18C illustrate examples of dynamic 2D and 3D icons which may be displayed on display 102, and how their appearance changes under a pressure exerted thereon. The examples of 2A-18C are for illustrative purposes and it is understood that the dynamic 2D and 3D icons may comprise a wide variety of other images in further embodiments.

FIG. 2A illustrates a dynamic 3D icon 110 including an image 114 of a sphere. The sphere is displayed in the x-y plane of display 102 as shown. However, using shading, perspective and other visual graphics effects, the image 114 in FIG. 2A may appear to have depth in the z direction perpendicular to the x-y plane. This apparent depth created by the visual effects in the 2D images is referred to herein as virtual depth, and is denoted by z′. FIG. 2B shows the virtual depth z′ in the z-direction of the image 114 on icon 110. As noted, this virtual depth is not real and would not be seen when viewed from the x-y plane. The virtual depth z′ shown in the figures is merely a representation of the apparent (virtual) depth created by the 3D visual effects in the 2D image 114.

In FIG. 2A, the dynamic 3D icon 110 is in an unbiased state; namely, no pressure is exerted on the icon 110, and the image 114 on the icon 110 of FIG. 2A is an unbiased sphere. The image 114 is a circle in the x-y plane (FIG. 2A) and a circle from a perspective of the virtual depth z′ (FIG. 2B). In accordance with aspects of the present technology, when a pressure is exerted on a dynamic 3D icon 110 along the z-axis, an appearance of the dynamic 3D icon 110 changes as a function of the exerted pressure. FIGS. 3A and 3B illustrate a change in the appearance of the sphere of FIG. 2A when a pressure is exerted on the dynamic 3D icon 110 by an external element 116. FIG. 3B shows the virtual depth z′ of the image 114 shown in FIG. 3A. The exerted pressure causes the image 114 of the sphere to compress and a virtual depth z′ of the sphere 114 to decrease in the direction of arrow 120. As noted, the external element 116 may for example be a finger, other body part or a stylus.

In addition to the image 114 compressing and the virtual depth z′ decreasing, the image 114 may undergo other visual effects changes upon application of a pressure to dynamic 3D icon 110. For example, when a real world ball is compressed from the top, it may expand at its sides. Thus, in one example shown in FIGS. 3A and 3B, the compressed sphere also expands in the directions of arrows 122. This type of visual effect may be referred to herein as a volumetric compression, as the image 114 appears to maintain its volume as it compresses under a pressure on the icon 110. The expansion may appear to be greater at different locations along the apparent (virtual) length of the image in the x-y plane, as shown in FIG. 3B. The expansion may, for example, be the greatest at a mid-section, m, along its apparent length. In embodiments, the expansion may appear to be symmetrical in all radial directions about a vertical axis. However, the image may expand more in one direction than another. For example, the image may appear to expand to a greater degree in the y-direction than in the x-direction.

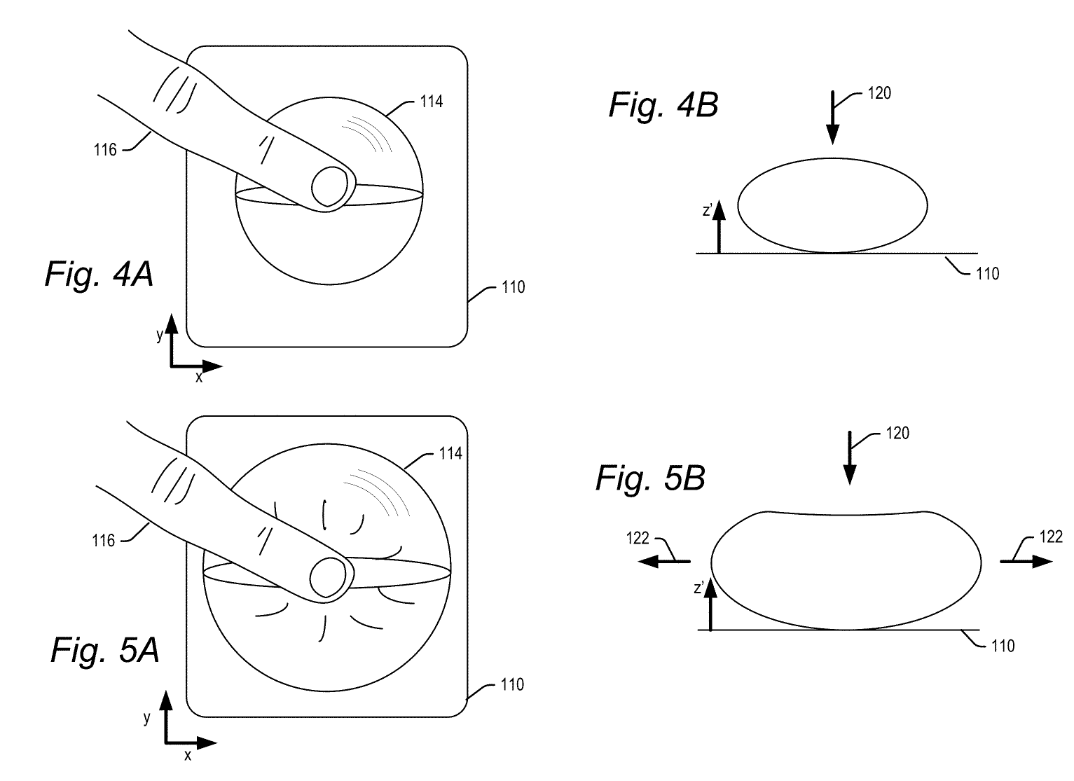

In a further embodiment shown in FIGS. 4A and 4B, upon applying a pressure to the icon 110 of FIG. 2A, the sphere may compress, but not expand outward at its sides. FIG. 4B shows the virtual depth z′ and perspective of the image 114 shown in FIG. 4A. This type of visual effect may be referred to herein as a depth compression.

When certain malleable real world objects such as for example balloons are compressed, they may bend or bow inward at the point of compression. Thus, in the example of FIGS. 5A and 5B, as the sphere compresses, it may also bend or bow inward at the point of contact. FIG. 5B shows the virtual depth z′ and perspective of the image 114 shown in FIG. 5A. This type of visual effect may be referred to herein as a malleable compression. Malleable compression may be a malleable volumetric compression (as shown in FIGS. 5A and 5B), where the sides of the image also expand outward in the direction of arrows 122. Malleable compressions may alternatively be a malleable depth compression (as shown in FIGS. 9A and 9B discussed below), where the sides of the image do not expand outward.

In embodiments including a malleable compression, the image 114 may bend inward at a center of a top surface of the image as shown for example in FIGS. 5A and 5B. However, in further embodiments of malleable compression, the touch sensitive display may detect that a user is contacting the dynamic 3D icon 110 off-center of the image 114, and bend inward at the point of off-center contact. The operating system of computing device 104 knows the position of the icons 110 on the display and knows the position of contact, and can thus determine when an icon 110 is contacted off-center.

The amount of compression (the change in the virtual depth) of an image 114 upon application of a pressure to dynamic 3D icon 110 may be defined according to any of various algorithmic functions which may be predefined for an icon and stored in a memory of the computing system 104. When a dynamic 3D icon is contacted, its associated algorithmic function(s) may be retrieved from memory and applied when changing the appearance of an icon 110 as a function of an exerted pressure. In one simple example, the change in virtual depth, Δz′, may be defined as:

Δz′=(P)(k) (1)

where P is a measure of the applied pressure, and k is a predefined constant. It is understood that the compression of an image may change as a function of pressure according to a wide variety of other equations, both linearly and non-linearly. Pressure is a force applied over a given area. In further embodiments, the display 102 may measure force instead of pressure, and the change in virtual depth may be defined as a function of applied force instead of pressure.

In embodiments including volumetric compression of images, equations may also be defined for changes in diameters of the image, along a virtual length of the image from its top to its bottom along the virtual depth z′, as a function of pressure. For example, as shown in FIG. 3B, the equation(s) used may provide for greater expansion of the image at its mid-section m than at a top or bottom of the image. In embodiments including malleable compression of images, equations may also be defined to show changes in an upper surface of the image in the x-y plane as a function of pressure (and also possibly as a function of the point of contact with the icon 110).

The images on different dynamic 3D icons 110 may each compress as a function of pressure in the same way, or the images on different dynamic 3D icons 110 may compress differently (according to different algorithmic functions stored in memory for different icons 110). The images on different dynamic 3D icons 110 may expand in volumetric compression in the same way, or the images on different dynamic 3D icons 110 may expand differently (according to different algorithmic functions stored in memory for different icons 110). And similarly, the upper surfaces of images on different dynamic 3D icons 110 may change in malleable compression in the same way, or the images on different dynamic 3D icons 110 may change differently (according to different algorithmic functions stored in memory for different icons 110).

In embodiments, the amount by which an image 114 on a dynamic 3D icon 110 compresses may bear some relation to the ease with which the real world object represented by the icon compresses under pressure. An image of a solid, rigid object on an icon 110 may compress less than an image of a softer, flexible object on another icon 110. Additionally, an anchor point for the image 114 may be defined somewhere in the x-y area of an icon 110, for example at a base of the image. As an image is compressed and changes as a function of pressure, the position of the image may move and change. However, the portion of the image at the anchor point may remain stationary and anchored to the anchor point.

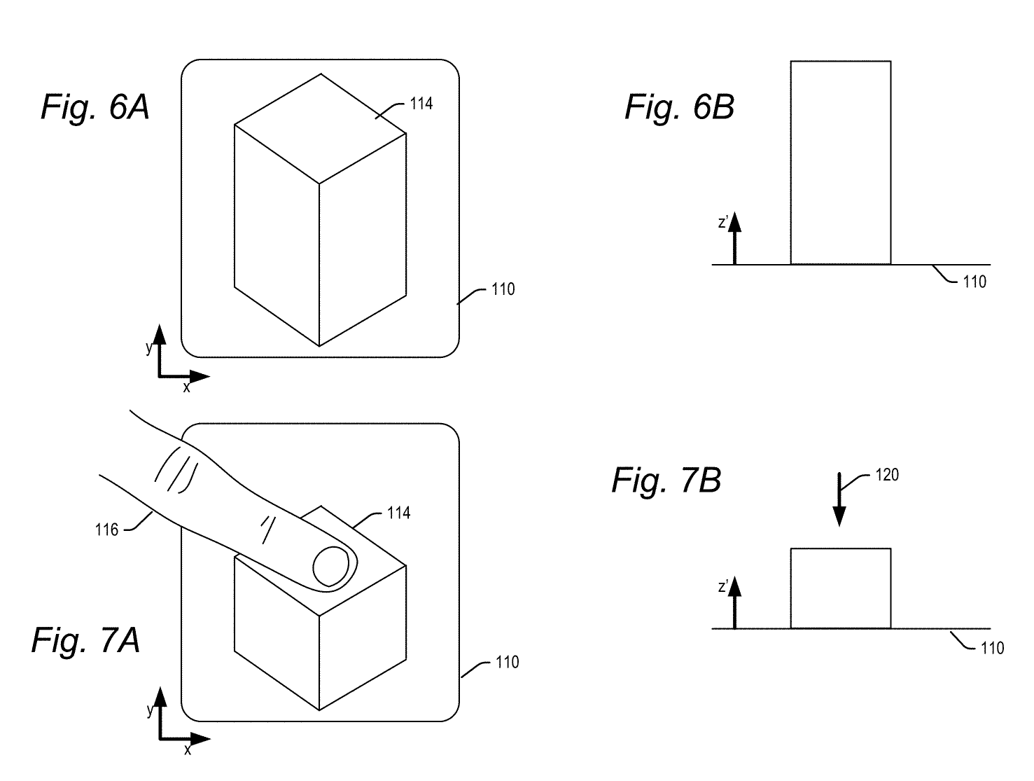

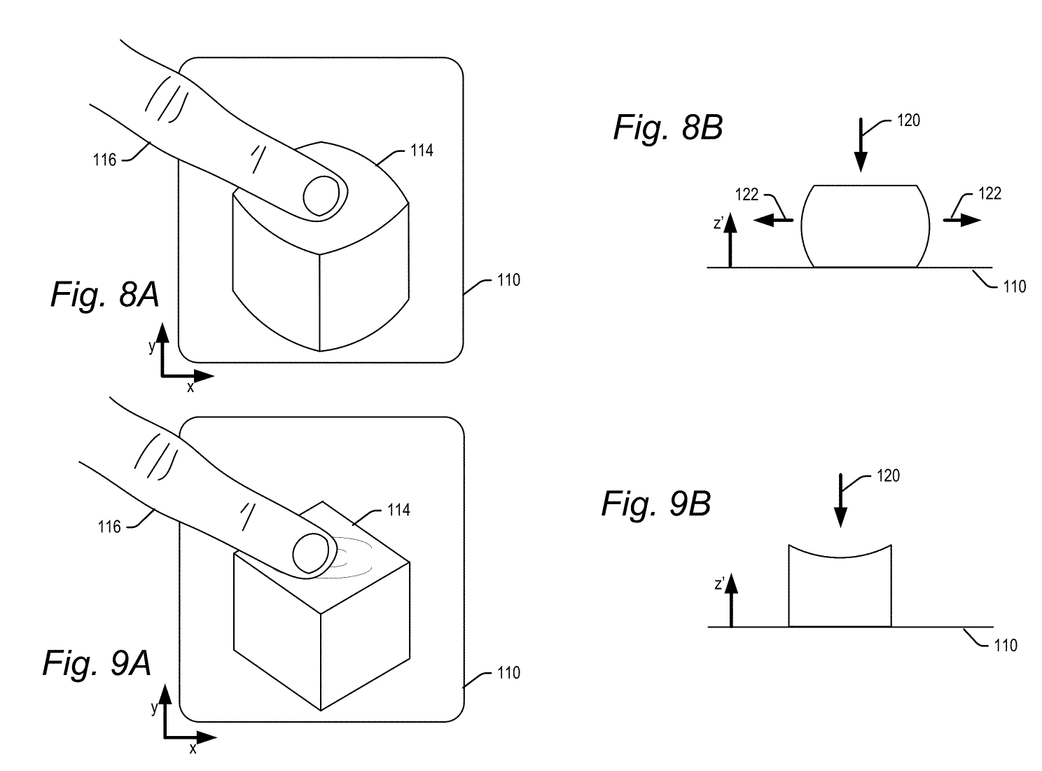

FIG. 6A shows an example of another dynamic 3D icon 110 where the image 114 is a cuboid in an unbiased state. FIG. 6B shows the virtual depth z′ and perspective of the image 114 of FIG. 6A. Upon application of a pressure on the dynamic 3D icon 110 of FIG. 6A, the image 114 on the icon changes appearance by giving the appearance of compressing, or shrinking in size in the virtual depth direction z′. FIGS. 7B, 8B and 9B show the virtual depth z′ and perspective of the image 114 of FIGS. 7A, 8A and 9A, respectively. FIGS. 7A and 7B show a depth compression of the cuboid; that is, apparent compression along the z-axis, no change in appearance in x or y-directions. FIGS. 8A and 8B show a volumetric compression of the cuboid; that is, apparent compression along the z-axis and expansion in the x-direction and/or y-direction along its apparent length. FIGS. 9A and 9B show a malleable depth compression; that is, apparent compression along the z-axis, no expansion along its apparent length, and a malleable bend in an upper surface of the image 114.

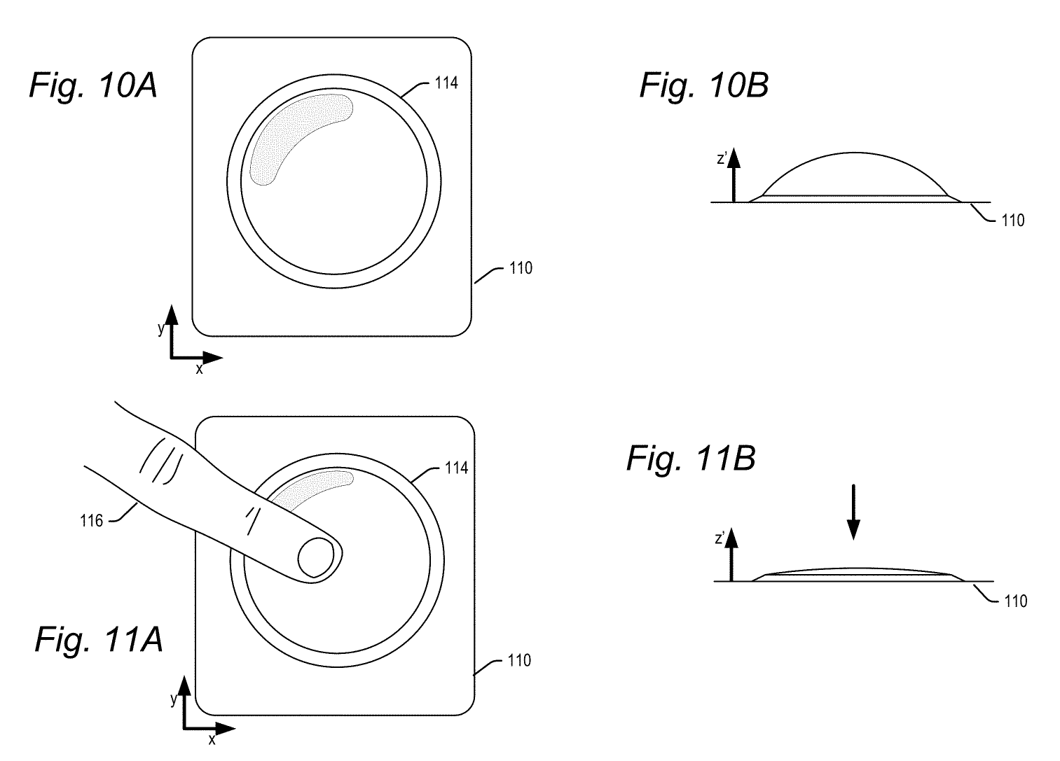

FIG. 10A shows an example of another dynamic 3D icon 110 where the image 114 is a button in an unbiased state. FIG. 10B shows the virtual depth z′ and perspective of the image 114 of FIG. 10A. Upon application of a pressure on the dynamic 3D icon 110 of FIG. 10A, the image 114 on the icon changes appearance by giving the appearance of the button being pressed, or shrinking in size in the virtual depth direction z′. FIG. 11B shows the virtual depth z′ and perspective of the image 114 of FIG. 11A. FIGS. 11A and 11B show a depth compression of the button; that is, apparent compression along the z-axis, no change in appearance in x or y-directions.

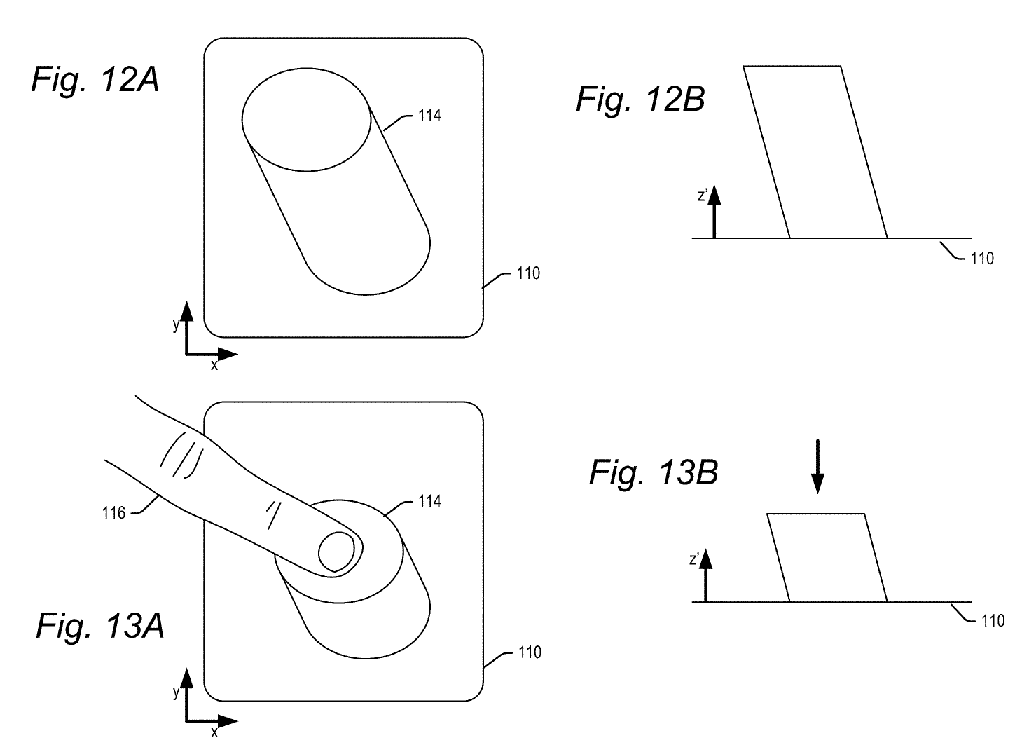

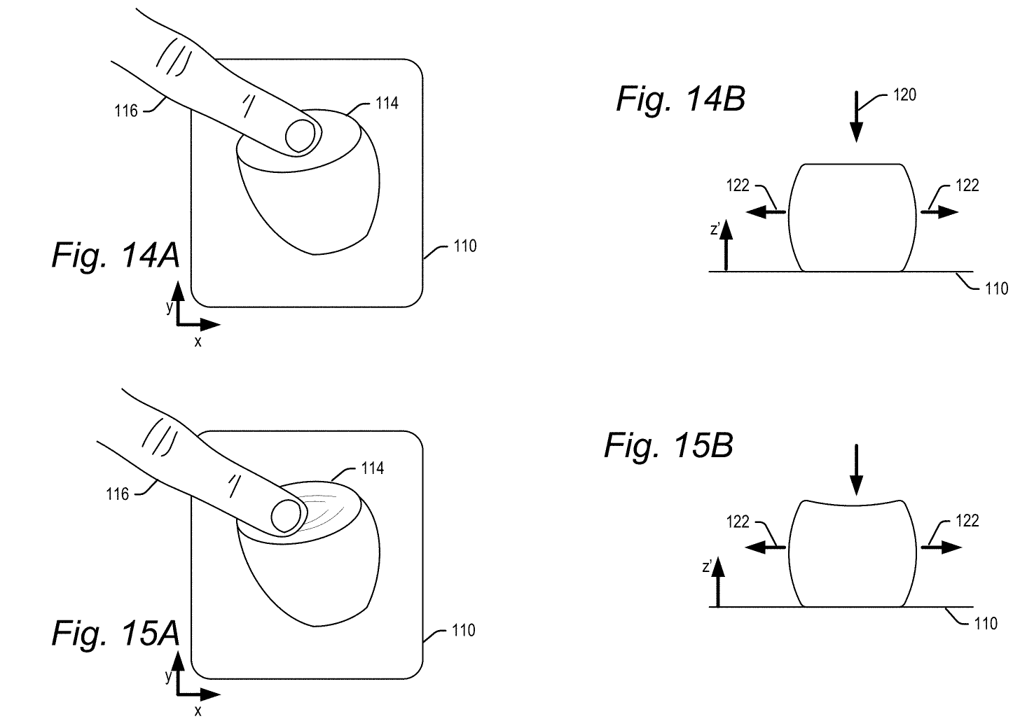

FIG. 12A shows an example of another dynamic 3D icon 110 where the image 114 is a canted or angled cylinder in an unbiased state. FIG. 12B shows the virtual depth z′ and perspective of the image 114 of FIG. 12A. Upon application of a pressure on the dynamic 3D icon 110 of FIG. 12A, the image 114 on the icon changes appearance by giving the appearance of compressing, or shrinking in size in the virtual depth direction z′. FIGS. 13B, 14B and 15B show the virtual depth z′ and perspective of the image 114 of FIGS. 13A, 14A and 15A, respectively. FIGS. 13A and 13B show a depth compression of the cylinder creating the visual effect of compression along the virtual z-axis, but with no change in appearance in x or y-directions. FIGS. 14A and 14B show a volumetric compression of the cuboid, including apparent compression along the z-axis and expansion in the x-direction and/or y-direction along its apparent length. FIGS. 15A and 15B show a malleable volumetric compression, including apparent compression along the z-axis, expansion along its apparent length, and a malleable bend in an upper surface of the image 114.

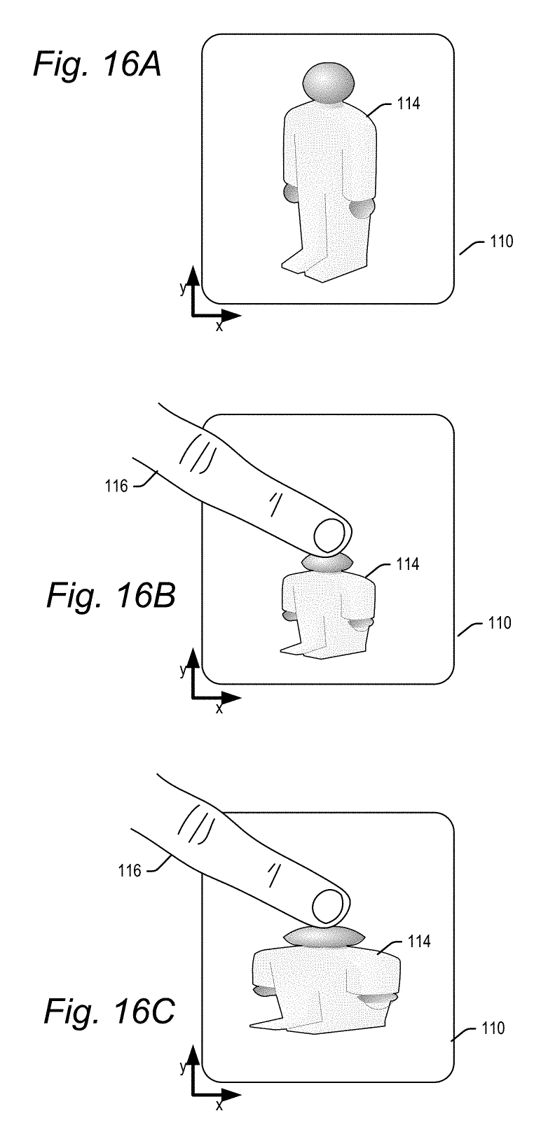

The images 114 may be shapes, but as noted above the images 114 may be pictures, symbols or any image. FIGS. 16A-16C illustrate a dynamic 3D icon 110 including an image 114 of a person. The image may appear to compress in the virtual depth z′ direction as a function of pressure as explained above. The compression may be a depth compression (FIG. 16B) or a volumetric compression (FIG. 16C).

In embodiments described above, pressing on a dynamic 3D icon 110 creates the impression of the image being compressed in the direction in which it is being pushed on (e.g., pushing down on an icon changes the virtual depth z′ of the image). This is intuitive as it mirrors how real world objects may compress when pushed on. However, it is conceivable that an image may change in shape and compress along an axis other than the apparent depth of the image.

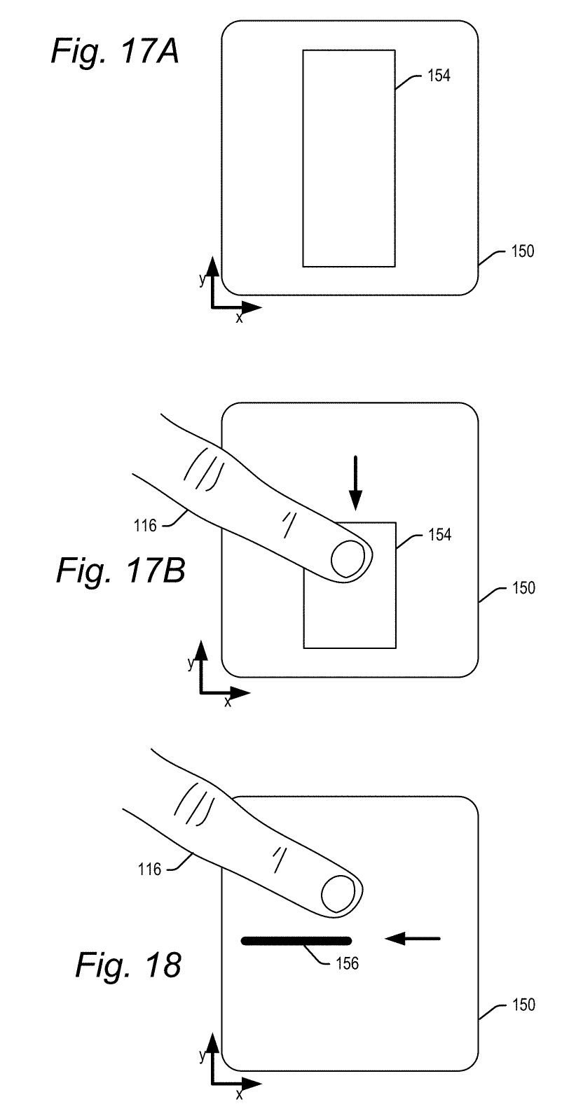

For example, FIGS. 17A-17B illustrate a 2D shape as an image 154 drawn vertically along the y-axis in the x-y plane of an icon 150. When a pressure is exerted down (z-direction) on the icon 150 by external element 116, the image 154 may compress in y-direction as shown in FIG. 17B. The amount the image 154 compresses along the y-direction may be a function of the applied pressure, as described above. The image may alternatively have a length along the x-axis and compresses along the x-axis. The object may have a length, and may compress, in some direction between the x-y axes (having both x and y components).

Instead of a 2D shape, the image may be a 1D shape, such as line 156 shown in FIG. 18. As above, when a pressure is exerted downward in the z-direction onto the icon 150, the length of the line 156 may change in the x direction (as shown), y-direction or along a direction between the x-axis and y-axis. The line 156 may change its length as a function of the pressure applied on the icon 150.

In the embodiments of FIGS. 17A-B and 18, the images 154 and 156 on icon 150 are flat (1D or 2D) and have no depth, virtual or otherwise. However, the image changes shape in the x-y plane of the display 102 as a function of applied pressure. Thus, the icon 150 in FIGS. 17A-B is referred to herein as a dynamic 2D icon, and the icon 150 in FIG. 18 is referred to herein as a 1D icon. While the examples of a rectangle and a line are used in FIGS. 17A-B and 18, it is understood that other shapes may be used on icon 150 in further embodiments. In a further example, instead of compressing (getting shorter) upon application of a pressure, the image 154, 156 in FIGS. 17A-B and 18 may get longer as a function of applied pressure.

In the embodiments described above with respect to FIGS. 2A-16C, a downward pressure in the z-direction changes the virtual depth z′ of the image. In FIGS. 17A-18, a downward pressure in the z-direction changes the length of the image in the x-y plane. In still further embodiments, instead of the image changing as a function of downward pressure in the z-direction, the image may change as a function moving contact of the user's hand or stylus in the x-y direction. Thus for example, in FIG. 2A, if a user were to swipe his/her finger down in the negative y-direction, the image 114 of the sphere may compress downward in the negative y-direction on icon 110. In FIG. 12A, a swipe of the user's hand in the positive x-direction may cause the cylinder to move to the right (in the positive x-direction), or bend to the right while remaining anchored at its base. In FIG. 17A, a swipe of the user's hand downward in the negative y-direction may cause the image 154 to compress in the y-direction as shown in FIG. 17B. In such embodiments, the image may change as a function of the left-right or up-swipe while in contact with the surface of the icon, and not as a function of downward pressure. In further embodiments, the image may change as a function of both the left-right, up-down contacting swipe and downward pressure on the icon.

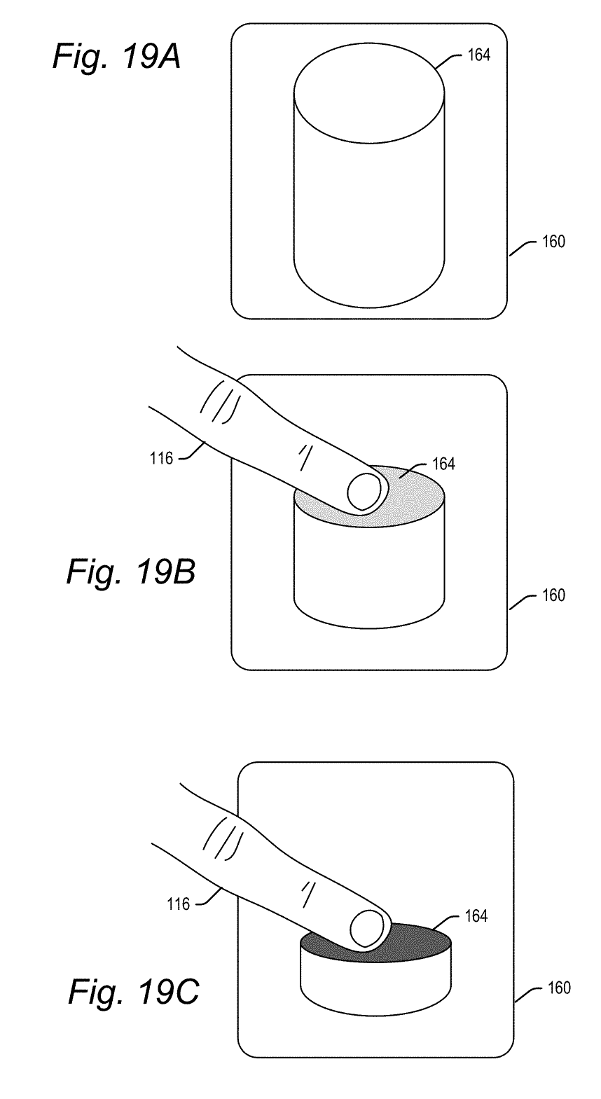

In embodiments described above, pressing on a dynamic icon 110, 114, 150 alters the appearance of an image on the icon by changing its shape. In further embodiments, instead of or in addition to changing its shape, the dynamic icon 110, 114, 150 may change its appearance by changing color. Such an embodiment is shown in FIGS. 19A-19C. An unbiased icon 160 is shown in FIG. 19A including an image 164. While the image 164 is shown as a cylinder, it is understood that the image 164 may be any other image in further embodiments.

Upon application of a pressure, the color of a portion of image 164, or all of image 164, may change. The color may change as a function of the pressure, for example to a first color upon application of a first pressure (FIG. 19B) and to a second color upon application of a second pressure (FIG. 19C). The change in color may be continuous or may jump discontinuously from color to color as explained below. The change in color may involve a change in color shade, for example getting darker as pressure increases. The change may involve changes in color, for example spanning the colors of the rainbow as pressure increases. The colors may alternatively change in any of a variety of other ways as a function of pressure. In the embodiment of FIGS. 19A-19C, the applied pressure may be converted to a numeric quantity, which is in turn mapped to a specific color in memory. Thus, the color of the image 164 may change as pressure changes. The applied pressure may be converted into a numeric quantity by any of a wide variety of algorithmic functions.

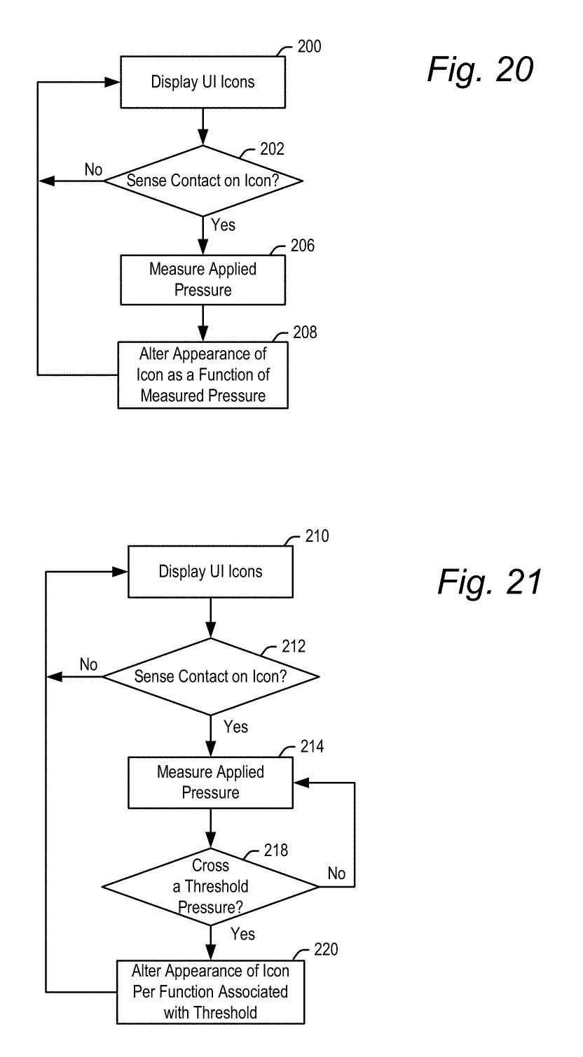

FIG. 20 is a flowchart illustrating the operation of one embodiment of the present technology. In step 200, the computing device 104 displays a user interface 100 including dynamic icons 110, 150 and/or 160. In step 202, a processor of the computing device looks for contact with a dynamic icon, as indicated by the touch-sensitive display 102. If contact is sensed, a pressure sensor associated with the display 102 measures the pressure applied to the icon in step 206. In step 208, a stored algorithmic function may be applied for the received pressures, and the appearance of the icon may be altered as a function of the measured pressure in accordance with any of the above-described embodiments. As noted, the appearance of a dynamic icon may change as a function of applied force instead of applied pressure.

In accordance with the above flow, the computing device 104 may update an appearance of the images and icons on the display 102 several times a second. Thus, the appearances of the dynamic icons may in effect change continuously with a change in pressure. For example, a virtual depth z′ of a dynamic 3D icon 114 may continuously get smaller as the pressure increases. In embodiments, a time delay may be built into the flow, such that an applied pressure will not register for, e.g., 1 to 3 seconds as a change in appearance. This time delay may be used to prevent changes in appearance to the icon that result from spurious and inadvertent applied pressures and pressure changes. It is understood that the time delay may be less than 1 second and greater than 3 seconds in further embodiments.

In further embodiments, the appearance of the dynamic icons may be updated discontinuously in discrete steps. In one example, the algorithmic function using pressure as the input may be a step function. Thus, the output of the function (e.g., change in virtual depth z′) stays steady until a step defined by the function is reached, and then the output changes.

In a further embodiment shown in the flowchart of FIG. 21, predefined pressure thresholds may be defined, and an appearance of the dynamic icon defined for each threshold. Thus, icons are displayed (step 210), contact is sensed (step 212) and pressure is measured (step 214) as described above. In step 218, the processor may check whether the applied pressure has crossed over a predefined threshold pressure value stored in memory. If so, the appearance of a dynamic icon may change in step 220 in accordance with a function associated with the stored threshold.

There may be several stored and predefined thresholds in the example of FIG. 21. Additionally, a threshold may be crossed from above or below. Thus, if pressure is increased past a threshold, the image on the icon may jump discontinuously to a more compressed stated. If the pressure is decreased past a threshold, the image on the icon may jump discontinuously to a less compressed state. As above, a time delay may be built into the flow, such that an applied pressure will not register for a period of time as a change in appearance to prevent changes in appearance from spurious and inadvertent applied pressures and pressure changes.

In the operation of the present technology in accordance with any of the above-described embodiments, application of one or more predefined pressures to an icon may actuate one or more computer operations. A computer operation may for example be launching or closing an application, changing a parameter of an application or operating system, opening or closing a file, or any other operation performed by a computer. A single dynamic icon may have several computer operations that are actuated at different pressures. In embodiments, the dynamic icon may change discontinuously to a new appearance each time a predefined pressure is reached that actuates a new computer operation. In this way, different appearances may be associated with different computer operations. Alternatively, the appearance may change continuously each time a predefined pressure is reached that actuates a new computer operation.

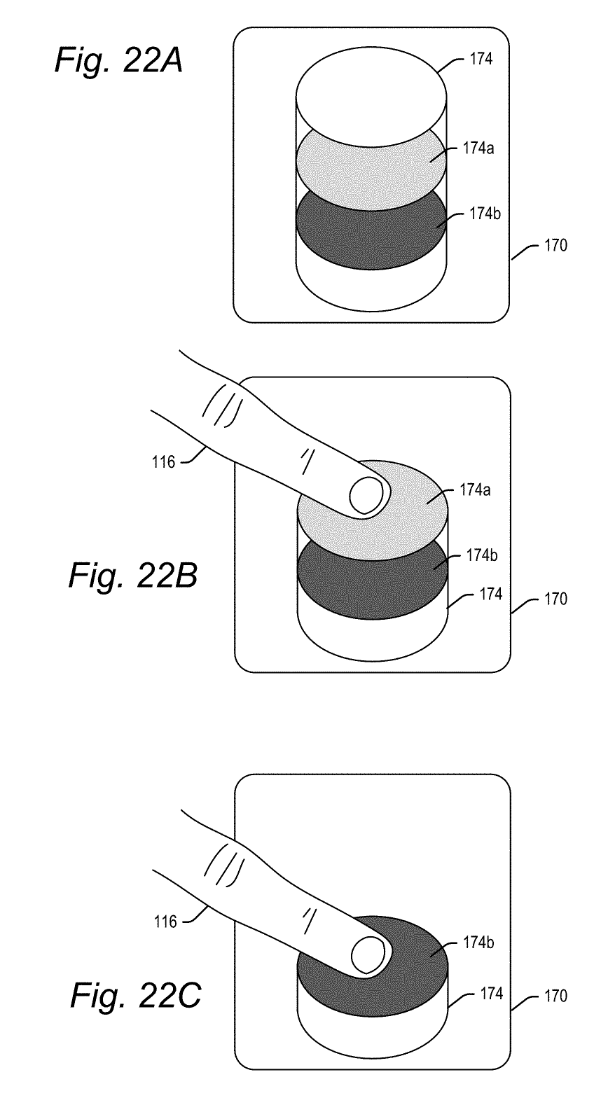

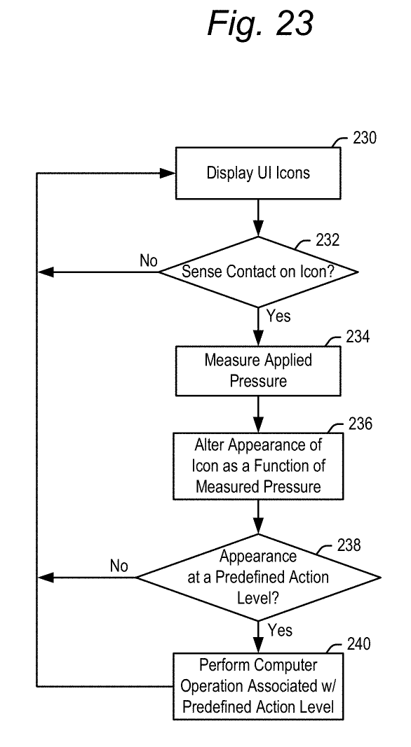

The illustrations of FIGS. 22A-C and the flowchart of FIG. 23 show an example of how a dynamic 3D icon may have predefined appearances, referred to herein as predefined action levels, that are associated with initiating different computer operations. In step 230 of FIG. 23, dynamic 3D icons are displayed, such as for example the dynamic 3D icon 170 of FIG. 22A. As seen, the dynamic 3D icon 170 may have an image 174 comprising level indicators 174a, 174b. In this embodiment, the level indicators are represented by two circles of different colors along the virtual length of the cylinder shown in image 174. While two level indicators are shown, there may be a single level indicator or more than two level indicators in further embodiments.

In step 232, contact is sensed and in step 234 pressure is measured as described above. In step 236, the appearance of the icon 170 is altered as a function of measured pressure as described above. In accordance with this embodiment, where the image 174 changes to a predefined action level in step 238, the operating system may initiate performance of a computer operation associated with the predefined action level in step 240. In the example shown in FIG. 22B, the dynamic 3D icon 170 may compress along its virtual length under pressure until the first level indicator 174a is shown in the top surface. If the icon 170 is pressed with a constant pressure (or a constant pressure plus or minus some predefined tolerance) so that the appearance shown in FIG. 22B is maintained for some predefined period of time, the computer operation associated with the first action level is performed. Requiring the image to be maintained for some predetermined period of time prevents unintended initiation of computer operations.

As noted above and shown in FIGS. 22A-22C, a dynamic 3D icon 170 may have multiple action levels associated with multiple computer operations. Thus, if the user presses harder on the icon 170 from the state illustrated in FIG. 22B, the icon 170 may compress further along its virtual length until the second level indicator 174b is shown at a top surface of the image 174 (FIG. 22C). If the icon 170 is held there with a constant pressure (or constant pressure plus/minus a tolerance) so that the appearance shown in FIG. 22C is maintained for some predefined period of time, the computer operation associated with the second action level is performed.

In the example shown in FIGS. 22A-22C, the level indicators are different colors, and the different action levels are reached when the different colors appear in an upper surface of the image 174. However, it is understood that a dynamic 3D icon may include a wide variety of level indicators represented by characteristics other than color. For example, different predefined shapes may represent different level indicators. When the image is changed as a function of pressure to a predefined shape, this may represent an action level which initiates a computer operation.

As a further example, in FIGS. 22A-22C, instead of colors, a ring (or annular shape) may be displayed at a top of the cylinder when an action level is reached. The level indicators may be characteristics unrelated to appearance in further embodiments. For example, when an action level is reached, a level indicator in the form of an audible sound may be played by the computing device. In a further example, the computing device may have a level indicator in the form of a haptic response when an action level is reached. Such a haptic response may be a vibration of the computing device. Other level indicators are contemplated.

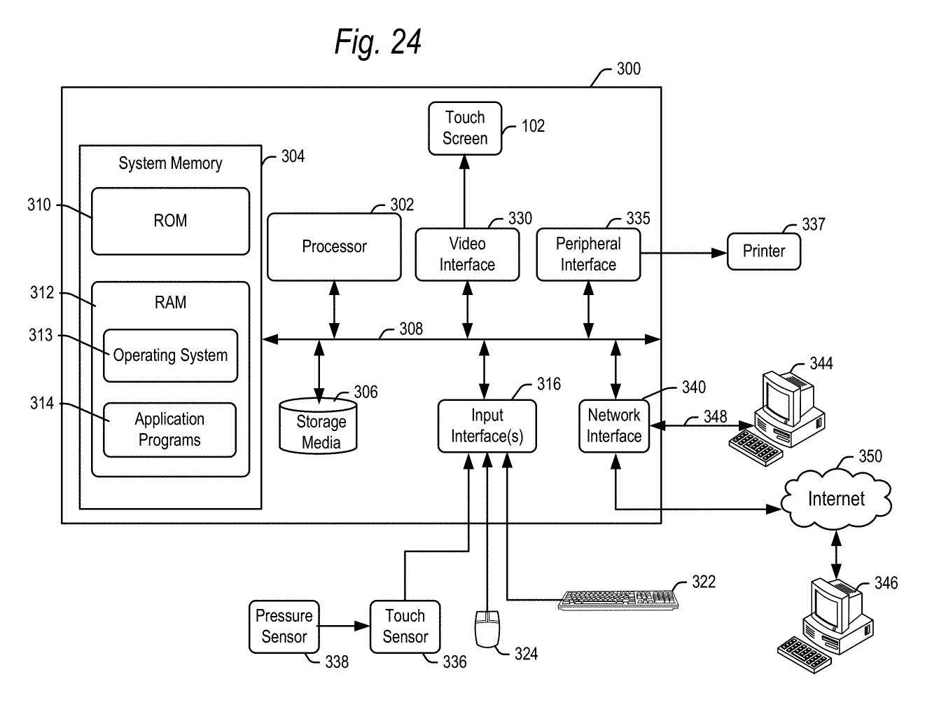

FIG. 24 illustrates details of a computing environment 300, which may be an example of computing device 104 as described herein, for implementing aspects of the present technology. Components of computing environment 300 may include, but are not limited to, a processor 302, a system memory 304, computer readable storage media 306, various system interfaces and a system bus 308 that couples various system components. The system bus 308 may be any of several types of bus structures including a memory bus or memory controller, a peripheral bus, and a local bus using any of a variety of bus architectures.

The computing environment 300 may include computer readable media. Computer readable media can be any available tangible media that can be accessed by the computing environment 300 and includes both volatile and nonvolatile media, removable and non-removable media. Computer readable media does not include transitory, modulated or other transmitted data signals that are not contained in a tangible media. The system memory 304 includes computer readable media in the form of volatile and/or nonvolatile memory such as ROM 310 and RAM 312. RAM 312 may contain an operating system 313 for computing environment 300. RAM 312 may also execute one or more application programs 314, including for example a routine for generating and/or operating a pressure-sensitive icon or icons. The computer readable media may also include storage media 306, such as hard drives, optical drives and flash drives.

The computing environment 300 may include a variety of interfaces for the input and output of data and information. Input interface 316 may receive data from different sources including touch (or contact) sensor 336 of touch-sensitive display 102, a mouse 324 and/or keyboard 322. A video interface 330 may be provided for interfacing with touch-sensitive display 102. It is understood that the touch sensor 336 may integrated as part of the touch screen 102. A peripheral interface 335 may be provided for supporting peripheral devices, including for example a printer 337.

A pressure sensor 338 may be integrated into touch sensor 336. Alternatively, the pressure sensor 338 may be separate from the touch sensor 336 and may provide its own input to input interface 316. Pressure sensor 338 may for example be a known pressure sensitive component for sensing pressure on the display 102, including for example a piezo-sensor, a capacitive sensor, a silicon sensor or other known sensors.

The computing environment 300 may operate in a networked environment via a network interface 340 using logical connections to one or more remote computers 344, 346. The logical connection to computer 344 may be a local area connection (LAN) 348, and the logical connection to computer 346 may be via the Internet 350. Other types of networked connections are possible, including broadband communications as described above. It is understood that the above description of computing environment 300 is by way of example only, and may include a wide variety of other components in addition to or instead of those described above.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device, comprising:
a display configured to display images;
a pressure sensor configured to sense at least one of a pressure and a force on the display; and
a processor configured to generate a dynamic icon having an image for display on the display, wherein the image is two-dimensional or three-dimensional in appearance, the processor changing an appearance of the image on the dynamic icon upon the pressure sensor sensing at least one of a pressure and a force on the dynamic icon.

2. The computing device of claim 1, the processor changing the appearance of the image comprising the processor changing a shape of at least a portion of the image.

3. The computing device of claim 1, the processor changing the appearance of the image comprising the processor changing a color of at least a portion of the image.

4. The computing device of claim 1, with the image including at least one of perspective, shading, or visual effects to appear to be three-dimensional and having a virtual depth out of a plane of the dynamic icon.

5. The computing device of claim 4, the processor changing the appearance of the image comprising compressing a virtual depth of the image.

6. The computing device of claim 5, the processor changing the appearance of the image comprising performing a volumetric compression by expanding a mid-section along a virtual depth of the image, in a dimension perpendicular to the virtual depth as the virtual depth of the image appears to compress.

7. The computing device of claim 5, the processor changing the appearance of the image comprising performing a malleable compression so as to display the image with an inward bend in an upper surface of the image.

8. The computing device of claim 1, the processor configured to actuate a computer operation upon the pressure increasing to a predefined pressure exerted on the dynamic icon, the image on the dynamic icon changing to a predefined appearance upon the pressure increasing to the predefined pressure and actuation of the computer operation.

9. The computing device of claim 1, the processor configured to actuate a first computer operation upon the pressure increasing to a first predefined pressure exerted on the dynamic icon, and the processor configured to actuate a second computer operation upon the pressure increasing to a second predefined pressure exerted on the dynamic icon, the image changing to a first appearance upon detection of the first predefined pressure on the dynamic icon, and the image changing to a second appearance upon the upon detection of the second predefined pressure on the dynamic icon.

10. The computing device of claim 1, an image of the images comprising one or more level indicators representing one or more predefined action levels, the processor configured to actuate a computer operation associated with a specific action level when a level indicator for the specific action level is indicated by the computing device.

11. A method, comprising:
displaying a dynamic icon on a graphical user interface, the dynamic icon comprising an image, wherein the image is two-dimensional or three-dimensional in appearance;
sensing a pressure exerted on the dynamic icon; and
changing the appearance of the image as a function of the sensed pressure exerted on the dynamic icon.

12. The method of claim 11, with changing the appearance of the image comprising changing a shape of at least a portion of the image.

13. The method of claim 11, with changing the appearance of the image comprising changing a color of at least a portion of the image.

14. The method of claim 11, with the image including at least one of perspective, shading, or visual effects to appear to be three-dimensional and having a virtual depth out of a plane of the dynamic icon.

15. The method of claim 14, with changing the appearance of the image including compressing a virtual depth of the image.

16. The method of claim 15, with changing the appearance of the image comprising performing a volumetric compression by expanding a mid-section along a virtual depth of the image, in a dimension perpendicular to the virtual depth as the virtual depth of the image appears to compress.

17. The method of claim 15, with changing the appearance of the image comprising performing a malleable compression so as to display the image with an inward bend in an upper surface of the image.

18. The method of claim 11, further comprising actuating a computer operation upon the pressure increasing to a predefined pressure exerted on the dynamic icon, the image on the dynamic icon changing to a predefined appearance upon the pressure increasing to the predefined pressure and actuation of the computer operation.

19. The method of claim 11, further comprising actuating a first computer operation upon the pressure increasing to a first predefined pressure exerted on the dynamic icon, and actuating a second computer operation upon the pressure increasing to a second predefined pressure exerted on the dynamic icon, the image changing to a first appearance upon detection of the first predefined pressure on the dynamic icon, and the image changing to a second appearance upon the upon detection of the second predefined pressure on the dynamic icon.

20. The method of claim 11, with an image of the images comprising one or more level indicators representing one or more predefined action levels, further comprising actuating a computer operation associated with a specific action level.

21. A non-transitory computer-readable medium storing computer instructions for operating a user interface, that when executed by one or more processors, cause the one or more processors to perform the steps of:
displaying a dynamic icon on the user interface, wherein the dynamic icon is two-dimensional or three-dimensional in appearance;
sensing a pressure exerted on the dynamic icon; and
changing the appearance of the image as a function of the sensed pressure exerted on the dynamic icon.
